(19) United States
(12) Patent Application Publication
(10) Pub. No.: US 2003/0187170 A1
(43) Pub. Date: Oct. 2, 2003

(54) Production of nano- and microstructured polymer films

(76) Inventor: Axel Burmeister, Buchholz (DE)

Correspondence Address: KURT BRISCOE, NORRIS, MCLAUGHLIN & MARCUS, P.A., 220 EAST 42ND STREET, 30TH FLOOR, NEW YORK, NY, 10017, US

(21) Appl. No.: 10/299,300

(22) Filed: Nov. 19, 2002

(30) Foreign Application Priority Data
Nov. 28, 2001 (DE) 101 58 347.8

(51) Int. Cl. C08F 212/34

(52) U.S. Cl. 526/307.8; 528/501

(57) ABSTRACT

A process for producing nanostructured and microstructured polymer films in which a polymer is guided into a gap formed by a roll and a means which develops an opposing pressure and the polymer is pressed through the gap so that, after the gap, the polymer lies in the form of a film on the roll, wherein wrapped around the roll is a form tool which is provided with a relief which represents the negative of the surface structure to be produced on the polymer film, so that the near-roll surface of the polymer film is shaped in accordance with the relief.

The invention relates to a process for producing nano- and microstructured polymer films. Surfaces having structures with sizes in the range from 10 nanometers up to 100 micrometers may represent solutions to problems in a very wide variety of spheres.

In the case of optical components, microstructures are able to split light and guide it in desired directions. Prism-structured films can be used as retroreflectors and roadway markings or on traffic signs.

Nonoptical applications of microstructured surfaces are self-cleaning surfaces (lotos effect), artificial sharkskin (streamlining) and abrasive papers.

The lotos effect and its industrial usefulness are disclosed in particular in WO 96/04123 A1. Accordingly, surfaces of articles may be made artificially self-cleaning by providing them artificially with a surface structure composed of elevations and depressions, ensuring that the distance between the elevations in the surface structure is in the range from 5 to 200 μm, preferably from 10 to 100 μm, and the height of the elevations is in the range from 5 to 100 μm, preferably from 10 to 50 μm, and ensuring that these elevations consist of hydrophobic polymers or durably hydrophobicized materials and that the elevations cannot be detached by water, either alone or with detergents.

Self-cleaning surfaces of this kind can be produced by providing the surface structures either during the production of the surfaces from hydrophobic polymers or else subsequently, and either by subsequent embossing or etching or by adhesive attachment of a powder of the hydrophobic polymers. Finally, it is possible to provide such self-cleaning surfaces on articles by subsequent durable hydrophobicization of surfaces produced beforehand and comprising the desired structures.

One possibility for subsequent durable hydrophobicization is the subsequent silanization of surfaces produced beforehand and comprising the desired structures. Silanization can be effected on any materials which are inherently hydrophilic but are capable of reacting with the reactive groups of the silanes, so that, ultimately, the surface is composed of the hydrophobic radicals of the silanes.

Of particular significance industrially are self-cleaning surfaces of articles which are transparent and for optical, esthetic or technical reasons are intended to maintain this transparency for a long time. Such surfaces include in particular those of transparent glazing systems for buildings, vehicles, solar collectors, etc. Also of economic and industrial importance, however, is the production of self-cleaning surfaces in the case of home exteriors, roofs, monuments, and tarpaulins, and in the case of internal coatings of silos, tanks or pipelines which may either contain aqueous solutions or may readily be cleaned by moving water without leaving any residue. The exterior coatings of vehicles such as cars, trains or aircraft are also of interest. In this case, however, it must be ensured that these surfaces are not subject to any severe mechanical stresses in the course of cleaning with moving water, since that would lead to leveling or polishing of the surface structures, which would consequently become glossy but would lose their self-cleaning ability.

Where it is not possible or desirable to produce the desired surface structures from the outset, it can also be done subsequently: for example, by subsequent embossing or etching. Embossing can be carried out, for example, using heated or heatable embossing dies. Etching can be carried out using the known means of chemical etching or by physical methods such as ion etching with oxygen or other jet systems which lead to roughening of the surface and so to a surface structure which can be used in accordance with the invention.

It has also been found that it is possible as well to obtain the desired surface structure by adhesively attaching a powder of the hydrophobic polymers. Powders of hydrophobic polymers having the desired particle size are available. Optimum results, however, are only achieved when using powders having a relatively narrow particle size distribution.

In addition to the methods of producing masterstructures that are known from WO 96/04123 A1, mention may be made, by way of example, of lithography, including grayscale lithography, micromilling and microcutting, laser ablation, etching, and sandblasting.

Another widespread process is the subsequent replication and reformation of master structures by means of electroplating in order to produce a mold; for example, the LIGA process.

These molds are then used as a starting point for further impressions in polymers in large numbers of units.

For producing large numbers of units, therefore, there are essentially four processes.

1. Injection Molding

In this case a melted polymer is injected under high pressure into a mold provided with a microstructure so that the negative of the mold and the structure is formed in the polymer. After the polymer melt has solidified within the injection mold, the mold is opened and the microstructured polymer is removed from the mold. This process is used, among other things, for producing audio CDs.

The disadvantage of injection molding is that only small areas can be produced in this way.

2. Radiation-Crosslinking Polymers

a) A support with a radiation-crosslinkable polymer is shaped by means of a transparent, structured die or a roll, then crosslinked by means of radiation through the die or through the roll. After crosslinking, the tool is removed again.

b) A transparent support with a radiation-crosslinkable polymer is shaped by means of a structured die or a roll, then crosslinked by means of radiation through the support. After crosslinking, the tool is removed again.

This process is described by way of example for electron beams and UV radiation in the 2001 conference proceedings of the RadTech Europe Conference and Exhibition, in the paper by Prof. Mehnert of 10/2001 on pages 603 to 608. Disadvantages of the radiation-crosslinking polymers are regarded as being that the selection of raw materials is restricted, the raw materials are in any case expensive, and filled colored polymer mixtures are possible only with severe restrictions.

3. Die Embossing

A thermoplastic polymer is embossed under high temperature and pressure using a structured metal die; after impression, the workpiece is cooled (to below the glass transition point) in order that the replicated structure is not destroyed when the die is withdrawn.

Subsequently, when using a polymer in web form, the operation can be repeated directly adjacently.

Advantageous features of die embossing include the fact that the process is highly suitable for replicating complex structures such as lenses and prisms and the fact that at the same time it is possible to achieve a very high quality of impression.

On the other hand, die embossing is a very time-consuming operation, a high level of tool wear is observed, a very severely pronounced seam is formed between two replicas, and it is necessary to operate a high level of mechanical complexity owing to the need for the tools to be in a planar position.

4. Rotary Embossing

A thermoplastic polymer in web form is embossed by means of a structured metal roll under high temperature and very high pressure. Following impression, the polymer can be cooled (to below the glass transition point) in order that the replicated structure is not destroyed when the die is withdrawn.

Here again there are a number of advantages and disadvantages.

Very high operating speeds are achieved. Moreover, a structuring results which is virtually seamless and which is particularly suitable for replicating diffraction gratings and/or holograms.

However, the process of rotary embossing is suitable only for polymers possessing great mechanical and thermal stability (PET). As in the case of die embossing, it is necessary to operate a very high level of mechanical complexity, under high pressure, because of the need for an absolutely planar position, and this makes it particularly difficult to scale up the process to large operating widths. Finally, rotary embossing is poorly suited to the impression of complex structures, lenses or prisms for example, or very high high structures.

It is an object of the invention to remedy this situation and, in particular, to provide a process which makes it possible to create nanostructured and microstructured surfaces and polymer films, while at the same time being technically uncomplicated. The process ought further to allow rapid manufacture, should combine the advantages of the two embossing processes (die embossing and rotary embossing), should enable high, complex structures to be impressed almost seamlessly, should feature an acceptable level of effort when scaling up the operating widths, and, finally, should allow the use even of sensitive polymers.

This object is achieved by a process as detailed in the main claim. The subclaims describe advantageous embodiments of the process. Also embraced by the concept of the invention are polymer films produced by the process of the invention.

The invention accordingly provides a process for producing nanostructured and microstructured polymer films in which a polymer is guided into a gap formed by a roll and a means which develops an opposing pressure. The polymer is pressed through the gap so that, after the gap, the polymer lies in the form of a film on the roll.

Wrapped around the roll is a form tool which is provided with a relief which represents the negative of the surface structure to be produced on the polymer film, so that the near-roll surface of the polymer film is shaped in accordance with the relief.

In one advantageous embodiment of the invention, the means is a doctor blade or backing roll.

It is very advantageous for the invention if the roll structured in this way is heated or cooled and/or if the means, especially the backing roll, is heated at above the melting point of the polymer used.

Further, preferably, the form tool is provided with the relief by sandblasting, etching, laser ablation, lithographic techniques, offset printing, electroplating techniques, LIGA and/or erosion.

The structures to be impressed can be structures in the lower nanometer range from 10 to 500 nm, preferably from 180 to 250 nm, such as motheyes for the antireflection coating of surfaces, in the lower micrometer range from 0.5 to 20 μm, preferably from 0.8 to 8 μm, such as diffraction gratings for holograms, in the upper micrometer and millimeter range from 5 to 500 μm, such as lenses and prisms for guiding and conducting light, and can also be raised, tangible structures such as indicia in heights and widths of several millimeters.

One particular advantage of this process is that structures with very different dimensions can be situated directly adjacent to one another on a form tool and yet still can be impressed in high quality.

Offset printing, developed from lithography, is an indirect printing process in which printing takes place not directly onto the form tool but instead first from the print carrier (which reads correctly) onto a cylinder provided with a rubber cloth (with the image now inverted), which in turn transfers the printed image the right way round onto the form tool. Since offset printing is a planographic printing process, printing and non-printing parts lie in one plane. The former are treated for oleophilicity, so that they take up printing ink while repelling water; in the non-printing parts of the print carrier, the opposite is the case.

By galvanotechnics in the narrower sense is meant the electrochemical surface treatment of materials, i.e. the electrolytic deposition of thin metallic (or, less commonly, nonmetallic) layers for the purpose of beautification, corrosion protection, the production of composite materials with enhanced properties, and the like.

The two main fields embraced by galvanotechnics are electroplating and electroforming. Electroforming is used to produce or reproduce articles by electrolytic deposition. First of all an impression (negative, hollow mold) is taken of the original in plaster, wax, guttapercha, silicone rubber, low-melting metal alloy, exposed and patterned photoresist, etc. The surface of the casting is made electrically conducting (by chemical deposition or vapor deposition of metals) and then, as the minus terminal, is coated with the metal to be deposited (for example Cu, Ni, Ag etc.; plus terminal) in the galvanizing liquid. When electrolysis is over, the layer of metal formed can be lifted from the mold.

Erosion describes a process in manufacturing in which a desired workpiece shape is obtained by controlled extraction of particles of material from the surface of the workpiece as a consequence of electrical spark discharges.

LIGA describes a combination of lithography with synchroton radiation, galvanoforming and impression, in order to produce microstructures for electronic circuits. The advantage of the process lies in the ability to manufacture these microstructures with structure heights ranging from several hundred micrometers down to very small lateral dimensions in the nanometer range.

More advantageously, the form tool is composed of a polymer such as crosslinked silicone, PET [polyethylene terephthalate] or polyester and/or a metal, nickel for example. For ease of application of the form tool it has a thickness of at least 10 μm plus the structure height.

The intention of the text below is to specify, by way of example, methods with which structures can be produced on the form tool.

As structures, the form tool may carry diffraction gratings having grid constants of from 1600 nm to 2100 nm with a depth of approximately 1000 nm. The diffraction gratings are arranged so that when irradiated with white light they produce an indicium with different colors. The structures are produced by mask exposure in a positive photoresist and subsequent removal of the unexposed regions on an Si wafer. Subsequently, these structures are vapor-deposited with about 100 nm of nickel in order to render them conductive, and finally are electroplated with nickel to a total thickness of 50 μm.

Grayscale lithography can be used to produce prisms having an edge length of 10 μm and a height of 7.5 μm. The process is essentially the same as that described above, except that exposure is carried out using a grayscale mask.

A laser is used to provide a polyester film with a holographic topography which repeats continuously on the film, giving a “scatterprint”.

In a brass blank, a diamond is used to cut so-called V-grooves with a depth of 20 μm.

In one particularly preferred variant of the process, the form tool is fastened detachably on the roll by means of a double-sided adhesive tape.

The carrier of the adhesive tape in question is preferably a polymeric film made of polypropylene. Alternatively to polypropylene, the use of, for example, PVC as carrier material is also possible.

To coat the outer faces of the carrier, two different adhesives are used. On the side of the adhesive tape that is placed against the carrier layer of the printing plate an extremely weakly adhering natural rubber adhesive is applied. The adhesive has a bond strength of from 0.2 to 7 N/cm, preferably 1 N/cm.

The other adhesive coating is formed by a strongly adhering film which is preferably likewise based on natural rubber. Alternatively, however, an adhesive based on conventional acrylates can also be used. This coating is characterized by a bond strength of from 2 to 6 N/cm, preferably 4.5 N/cm.

The bond strengths specified are measured in accordance with AFERA 4001.

With further preference it is possible to use a double-sided adhesive tape whose carrier is a film of polyethylene terephthalate (PET) with self-adhesive coatings applied to both of its sides.

The surface of the polyethylene terephthalate (PET) film is roughened on one or both sides at least partially using a reagent, which in the specific case brings about etching, and/or the surface energy of the film surface is increased so that the anchoring of adhesive to the film is optimized.

For this reason, a foamed carrier may be present between the film of polyethylene terephthalate (PET) and at least one adhesive.

It is advantageous, moreover, if the foamed carrier is composed of polyurethane, PVC or polyolefin(s).

It is further preferred if the surfaces of the foamed carrier have been physically pretreated, especially corona pretreated.

More preferably, the film of polyethylene terephthalate (PET) has a thickness of from 5 μm to 500 μm, preferably from 5 μm to 60 μm, with very particular preference 23 μm.

In order to obtain very good roughening results it is advisable to use, as the reagent, trichloroacetic acid (Cl₃C—COOH) alone or in combination with inert crystalline compounds, preferably silicon compounds, with particular preference [SiO₂]ₓ.

The purpose of the inert crystalline compounds is to become incorporated into the surface of the PET film in order to increase the roughness and the surface energy.

In order to set the desired properties in the adhesive tape in a targeted manner, particularly the requisite cohesion, it is possible to add tackifier resins and fillers such as, inter alia, hydrocarbon resins, plasticizers, aging inhibitors or chalk to the adhesives.

In this particular case it has proved advantageous to use two different adhesives to coat the two outer faces of the carrier.

On one side of the adhesive tape, then, a weakly adhering acrylic adhesive is applied. The adhesive has in particular a bond strength of from 0.5 to 5 N/cm, preferably 2.5 N/cm.

The other adhesive coating is then formed by a more strongly adhering film, preferably likewise based on acrylate. This coating is characterized in particular by a bond strength of 1 to 6 N/cm, preferably 4.5 N/cm. The bond strengths specified are measured in accordance with AFERA 4001.

The desired bond strengths of the respective layer can be varied by the nature and amount of the resins used and of the fillers that are used.

The form tool is therefore preferably produced from a roll or a sleeve. With further preference, the tool is composed of a polymer such as crosslinked silicone and/or PET and/or a metal. In one outstanding embodiment, then, the structure depth of the surface of the form tool is between 10 nm and 10,000 μm.

In the process of the invention, the polymer to be structured is advantageously in a completely softened form or in a melt form during shaping, and forms a rotating bead in the shaping roll gap.

As the polymer it is possible with very great advantage to use a polyolefin such as polypropylene or polyethylene.

The thermoplastic polyolefins include, in particular, at least one polyolefin from the group of the polyethylenes (for example, HDPE, LDPE, MDPE, LLDPE, VLLDPE, copolymers of ethylene with polar comonomers) and the group of the polypropylenes (for example, polypropylene homopolymers, random polypropylene copolymers or block polypropylene copolymers).

It is preferred to use mixtures of different suitable polyolefins.

Generally speaking, thermoplastics are outstandingly suitable for the requirements imposed. They include all plastics which are composed of linear or thermolabile, crosslinked polymer molecules, examples being polyolefins, vinyl polymers, polyamides, polyesters, polyacetals, polycarbonates, and to some extent polyurethanes and ionomers as well. In other words, the thermoplastics embrace polymers whose level of properties extends from that of the bulk plastics through that of the high-performance plastics (specialty plastics). A transition group between these two classes of plastics is formed by the polymers referred to as engineering thermoplastics. An overview of the most important representatives is provided by the following diagram:

[image]

The polymer is preferably thermoplastic, a polymer blend and/or a polymer-bound release, such as, in particular, N,N′-ethylenebisstearamide.

The polymer may also have been blended with colorants such as TiO₂ or carbon black and/or with fillers such as chalk.

In order to support the polymer film there is preferably a self-contained process support present which is guided via the means and the roll in such a way that the polymer or polymer film is continually situated between process support and roll.

In a further advantageous embodiment of the process, the polymer film is produced on a support material which on the roll-remote side of the polymer is guided into the gap formed by roll and means and is guided along the roll surfaces.

In an alternative embodiment, the polymer film is produced on a support material which is guided on the roll-remote side of the elastomeric polymer, after the gap formed by roll and means, onto the roll. This approach is especially appropriate if the support material to be coated is not up to thermal or mechanical stresses in the roll gap.

The support material is supplied to the roll, for example, by means of a contact roll.

The polymer can be supplied to the roll gap by an upstream pair of rolls, by an extruder, or as a web, in such a way that a rotating polymer bead is formed within the roll gap.

This rotating bead on the one hand transports bubble-shaped air inclusions from the roll gap to the surface of the bead and on the other hand ensures uniform wetting of the form tool, even when structures differing greatly in form and [symbol] are to be modeled immediately adjacent to one another.

The support material together with the polymer film is then removed from the roll, by a take-off roll, for example.

In this way, laminates may be formed, especially if the support material is likewise a polymer film.

The support layer may further be formed by films (for example of PU, PE or PP, PET, PA), nonwovens, wovens, foams, metallized films, composites, cotton, laminates, foamed films, paper, etc.

Likewise serving as support layer is preferably a thermoplastic polyolefin film which is unoriented and includes at least one polyolefin from the group of the polyethylenes (for example HDPE, LDPE, MDPE, LLDPE, VLLDPE, copolymers of ethylene with polar comonomers) and the group of polypropylenes (for example, polypropylene homopolymers, random polypropylene copolymers or block polypropylene copolymers). It is preferred to use mixtures of different suitable polyolefins.

Outstandingly in accordance with the invention it is possible to use, as films, monoaxially and biaxially oriented films based on polyolefins: films, then, based on oriented polyethylene or oriented copolymers containing ethylene units and/or polypropylene units.

Monoaxially oriented polypropylene is distinguished by its very high tensile strength and low elongation in the machine direction and is used, for example, to produce strapping tapes. Particular preference is given to monoaxially oriented films based on polypropylene.

The thicknesses of the monoaxially oriented films based on polypropylene are preferably from 5 μm to 500 μm, with particular preference from 5 μm to 60 μm.

Monoaxially oriented films are predominantly single-layer films, although in principle multilayer monoaxially oriented films can be produced as well. Those known predomonantly include one-, two- and three-layer films, although the number of layers chosen can also be greater.

Particular preference is further given to biaxially oriented films based on polypropylene, having a draw ratio in the machine direction of between 1:4 and 1:9, preferably between 1:4.8 and 1:6, and a draw ratio in cross direction of between 1:4 and 1:9, preferably between 1:4.8 and 1:8.5.

An example of a suitable support material is a metallocene-polyethylene nonwoven.

The properties of the metallocene-polyethylene nonwoven are preferably as follows:

a basis weight of from 40 to 200 g/m², in particular from 60 to 120 g/m², and/or

a thickness of from 0.1 to 0.6 mm, in particular from 0.2 to 0.5, and/or

a machine-direction ultimate tensile strength elongation of from 400 to 700% and/or

a cross-direction ultimate tensile strength elongation of from 250 to 550%.

As support or carrier material it is possible to use all known textile carriers such as wovens, knits, lays or nonwoven webs; the term “web” embraces at least textile sheetlike structures in accordance with EN 29092 (1988) and also stitchbonded nonwovens and similar systems.

It is likewise possible to use spacer fabrics, including wovens and knits, with lamination. Spacer fabrics of this kind are disclosed in EP 0 071 212 B1. Spacer fabrics are matlike layer structures comprising a cover layer of a fiber or filament fleece, an underlayer and individual retaining fibers or bundles of such fibers between these layers, said fibers being distributed over the area of the layer structure, being needled through the particle layer, and joining the cover layer and the underlayer to one another. As an additional though not mandatory feature, the retaining fibers in accordance with EP 0 071 212 B1 comprise inert mineral particles, such as sand, gravel or the like, for example.

The holding fibers needled through the particle layer hold the cover layer and the underlayer at a distance from one another and are joined to the cover layer and the underlayer.

Spacer wovens or spacer knits are described, inter alia, in two articles, namely

an article from the journal kettenwirk-praxis 3/93, 1993, pages 59 to 63, “Raschelgewirkte Abstandsgewirke” [Raschel-knitted spacer knits]

and

an article from the journal kettenwirk-praxis 1/94, 1994, pages 73 to 76, “Raschelgewirkte Abstandsgewirke”,

the content of said articles being included here by reference and being part of this disclosure and invention.

Suitable nonwovens include, in particular, consolidated staple fiber webs, but also filament webs, meltblown webs, and spunbonded webs, which generally require additional consolidation. Known, possible consolidation methods for webs are mechanical, thermal, and chemical consolidation. Whereas with mechanical consolidations the fibers are usually held together purely mechanically by entanglement of the individual fibers, by the interlooping of fiber bundles or by the stitching-in of additional threads, it is possible by thermal and by chemical techniques to obtain adhesive (with binder) or cohesive (binderless) fiber-fiber bonds. Given appropriate formulation and an appropriate process regime, these bonds may be restricted exclusively, or at least predominantly, to the fiber nodal points, so that a stable, three-dimensional network is formed while retaining the loose open structure in the web.

Webs which have proven particularly advantageous are those consolidated in particular by overstitching with separate threads or by interlooping.

Consolidated webs of this kind are produced, for example, on stitchbonding machines of the “Malifleece” type from the company Karl Mayer, formerly Malimo, and can be obtained, inter alia, from the companies Naue Fasertechnik and Techtex GmbH. A Malifleece is characterized in that a cross-laid web is consolidated by the formation of loops from fibers of the web.

The carrier used may also be a web of the Kunit or Multiknit type. A Kunit web is characterized in that it originates from the processing of a longitudinally oriented fiber web to form a sheetlike structure which has the heads and legs of loops on one side and, on the other, loop feet or pile fiber folds, but possesses neither threads nor prefabricated sheetlike structures. A web of this kind has been produced, inter alia, for many years, for example on stitchbonding machines of the “Kunitvlies” type from the company Karl Mayer. A further characterizing feature of this web is that, as a longitudinal-fiber web, it is able to absorb high tensile forces in the longitudinal direction. The characteristic feature of a Multiknit web relative to the Kunit is that the web is consolidated on both the top and bottom sides by virtue of the double-sided needle punching.

Finally, stitchbonded webs are also suitable as an intermediate for forming an adhesive tape of the invention. A stitchbonded web is formed from a nonwoven material having a large number of stitches extending parallel to one another. These stitches are brought about by the incorporation, by stitching or knitting, of continuous textile threads. For this type of web, stitchbonding machines of the “Maliwatt” type from the company Karl Mayer, formerly Malimo, are known.

Also particularly advantageous is a staple fiber web which is mechanically preconsolidated in the first step or is a wet-laid web laid hydrodynamically, in which between 2% and 50% of the web fibers are fusible fibers, in particular between 5% and 40% of the fibers of the web.

A web of this kind is characterized in that the fibers are laid wet or, for example, a staple fiber web is preconsolidated by the formation of loops from web fibers or by needling, stitching or air-jet and/or water-jet treatment.

In a second step, thermofixing takes place, with the strength of the web being increased again by the (partial) melting of the fusible fibers.

The web carrier may also be consolidated without binders, by means for example of hot embossing with structured rolls, with properties such as strength, thickness, density, flexibility, and the like being controllable via the pressure, temperature, residence time, and embossing geometry.

For the use of nonwovens in accordance with the invention, the adhesive consolidation of mechanically preconsolidated or wet-laid webs is of particular interest, it being possible for said consolidation to take place by way of the addition of binder in solid, liquid, foamed or pastelike form. A great diversity of theoretical embodiments is possible: for example, solid binders as powders for trickling in, as a sheet or as a mesh, or in the form of binding fibers. Liquid binders may be applied as solutions in water or organic solvent or as a dispersion. For adhesive consolidation, binder dispersions are predominantly chosen: thermosets in the form of phenolic or melamine resin dispersions, elastomers as dispersions of natural or synthetic rubbers, or, usually, dispersions of thermoplastics such as acrylates, vinyl acetates, polyurethanes, styrene-butadiene systems, PVC, and the like, and also copolymers thereof. Normally, the dispersions are anionically or nonionically stabilized, although in certain cases cationic dispersions may also be of advantage.

The binder may be applied in a manner which is in accordance with the prior art and for which it is possible to consult, for example, standard works of coating or of nonwoven technology such as “Vliesstoffe” (Georg Thieme Verlag, Stuttgart, 1982) or “Textiltechnik-Vliesstofferzeugung” (Arbeitgeberkreis Gesamttextil, Eschborn, 1996).

For mechanically preconsolidated webs which already possess sufficient composite strength, the single-sided spray application of a binder is appropriate for effecting specific changes in the surface properties.

Such a procedure is not only sparing in its use of binder but also greatly reduces the energy requirement for drying. Since no squeeze rolls are required and the dispersions remain predominantly in the upper region of the web material, unwanted hardening and stiffening of the web can very largely be avoided.

For sufficient adhesive consolidation of the web carrier, the addition of binder in the order of magnitude of from 1% to 50%, in particular from 3% to 20%, based on the weight of fiber web, is generally required.

The binder may be added as early as during the manufacture of the web, in the course of mechanical preconsolidation, or else in a separate process step, which may be carried out in-line or off-line. Following the addition of the binder it is necessary temporarily to generate a condition in which the binder becomes adhesive and adhesively connects the fibers—this may be achieved during the drying, for example, of dispersions, or else by heating, with further possibilities for variation existing by way of areal or partial application of pressure. The binder may be activated in known drying tunnels, or else, given an appropriate selection of binder, by means of infrared radiation, UV radiation, ultrasound, high-frequency radiation or the like. For the subsequent end use it is sensible, although not absolutely necessary, for the binder to have lost its tack following the end of the web production process.

A further, special form of adhesive consolidation consists in activating the binder by incipient dissolution or swelling. In this case it is also possible in principle for the fibers themselves, or admixed special fibers, to take over the function of the binder. Since, however, such solvents are objectionable on environmental grounds, and/or are problematic in their handling, for the majority of polymeric fibers, this process is not often employed.

Starting materials envisaged for the textile carrier include, in particular, polyester, polypropylene, viscose or cotton fibers. The present invention is, however, not restricted to said materials; rather it is possible to use a large number of other fibers to produce the web, this being evident to the skilled worker without any need for inventive activity.

Knitted fabrics are produced from one or more threads or thread systems by intermeshing (interlooping), in contrast to woven fabrics, which are produced by intersecting two thread systems (warp and weft threads), and nonwovens (bonded fiber fabrics), where a loose fiber web is consolidated by heat, needling or stitching or by means of water jets.

Knitted fabrics can be divided into weft knits, in which the threads run in transverse direction through the textile, and warp knits, where the threads run lengthwise through the textile. As a result of their mesh structure, knitted fabrics are fundamentally pliant, conforming textiles, since the meshes are able to stretch lengthways and widthways, and have a tendency to return to their original position. In high-grade material, they are very robust.

One particular embodiment of the carrier further consists in the use of a paper or a film, which has been given an antiadhesive treatment and is coated on one side with a self-adhesive composition and is supplied to the polymer that is to be structured with its self-adhesive side.

By way of example, it is possible to use a paper carrier having a density of from 1.1 to 1.25 g/cm³, the paper carrier having essentially one top side and one bottom side.

On the top and/or bottom side(s), the paper carrier has been provided with a plastics coating, and on at least one of the two plastics coatings which may be present an antiadhesive layer has been applied.

The paper carrier preferably has a density of from 1.12 to 1.2 g/cm³, in particular from 1.14 to 1.16 g/cm³.

With further preference, the paper carrier has a basis weight of from 40 to 120 g/m², more preferably from 50 to 110 g/m², with very particular preference from 60 bis 100 g/m².

In a further advantageous embodiment, the paper carrier is a highly densified glassine paper provided on the top and bottom sides with a plastics coating, with an antiadhesive layer, in particular a silicone coating, having been applied to both plastics coatings.

Plastics coatings used include, in particular, polyolefins such as LDPE, HDPE, blends of these two, for example, MDPE, PP or PTE. LDPE is especially advantageous.

The poly-coated sides of the paper carrier of LDPE or HDPE, moreover, can be produced so as to be matt or glossy.

With further preference, the plastics coating is applied at from 5 to 30 g/m², preferably from 10 to 25 g/m², with very particular preference from 15 to 20 g/m².

Particularly in the case of polyester, the application rate may be as low as from 2 to 3 g/m².

Furthermore, one outstanding embodiment exists when silicone, paraffin, Teflon or waxes, for example, are used as anti-adhesive layers. In that case it is possible to employ silicone-free release layers, for example, “non Silicone” from Rexam, or low-silicone release layers, for example “Lo ex” from Rexam.

Depending on the release material of the invention that is used in the specific case, it is possible to configure the antiadhesive layers on both sides of the release material to have the same or different release effect, i.e., to set different release properties on either side (controlled release).

It is preferred to use solventlessly coated silicone.

With further preference, the solventlessly coated silicone is applied at from 0.8 to 3.7 g/m², more preferably from 1.3 to 3.2 g/m², with very particular preference from 1.8 to 2.8 g/m².

Solventborne systems are also possible, however, and are applied at rates of in particular from 0.3 to 1 g/m².

Also embraced by the concept of the invention is a polymer film which is produced by the process of the invention, and the use thereof as carrier in a self-adhesive tape which is produced with the aid of a hotmelt adhesive, in particular a pressure sensitive hotmelt adhesive, by applying the self-adhesive composition to one side of the polymer film, specifically to the nonstructured surface.

The self-adhesive tape may then be wound up into a roll.

As adhesives it is possible to use substantially all known adhesives possessing sufficient bond strength to the bond substrate that is to be packed.

The adhesive of the adhesive tape may be composed of an adhesive based on solventborne natural rubber adhesives and acrylic adhesives. Preference is given to adhesives based on acrylic dispersions; adhesives based on styrene-isoprene-styrene block copolymers are particularly preferred. These adhesive technologies are known and are used in the adhesive tape industry.

The coatweight of the adhesive on the carrier material is preferably from 15 to 60 g/m². In a further preferred embodiment, the coatweight set is from 20 to 30 g/m².

The adhesive tapes can be produced by known methods. An overview of customary production methods can be found, for example, in “Coating Equipment”, Donatas Satas in Handbook of Pressure Sensitive Adhesive Technology, second edition, edited by Donatas Satas, Van Nostrand Reinhold New York pp. 767-808. The known methods of drying and slitting the adhesive tapes are likewise to be found in the Handbook of Pressure Sensitive Adhesive Technology, pp. 809-874.

A suitable adhesive composition is one based on acrylic hotmelt, having a K value of at least 20, in particular more than 30 (measured in each case in 1% strength by weight solution in toluene at 25° C.), obtainable by concentrating a solution of such a composition to give a system which can be processed as a hotmelt.

Concentrating may take place in appropriately equipped vessels or extruders; particularly in the case of accompanying devolatilization, a devolatilizing extruder is preferred.

An adhesive of this kind is set out in DE 43 13 008 C2. In an intermediate step, the solvent is removed completely from the acrylate compositions prepared in this way.

The K value is determined in particular in analogy to DIN 53 726.

In addition, further volatile constituents are removed. After coating from the melt, these compositions contain only small fractions of volatile constituents. Accordingly, it is possible to adopt all of the monomers/formulations claimed in the above-cited patent. A further advantage of the compositions described in the patent is that they have a high K value and thus a high molecular weight. The skilled worker is aware that systems with higher molecular weights may be crosslinked more efficiently. Accordingly, there is a corresponding reduction in the fraction of volatile constituents.

The solution of the composition may contain from 5 to 80% by weight, in particular from 30 to 70% by weight, of solvent.

It is preferred to use commercially customary solvents, especially low-boiling hydrocarbons, ketones, alcohols and/or esters.

Preference is further given to using single-screw, twin-screw or multiscrew extruders having one or, in particular, two or more devolatilizing units.

The adhesive based on acrylic hotmelt may contain copolymerized benzoin derivatives, such as benzoin acrylate or benzoin methacrylate, for example, acrylates or methacrylates. Benzoin derivatives of this kind are described in EP 0 578 151 A.

The adhesive based on acrylic hotmelt may be UV-crosslinked. Other types of crosslinking, however, are also possible, an example being electron beam crosslinking.

In one particularly preferred embodiment, self-adhesive compositions used comprise copolymers of (meth)acrylic acid and esters thereof having from 1 to 25 carbon atoms, maleic, fumaric and/or itaconic acid and/or esters thereof, substituted (meth)acrylamides, maleic anhydride, and other vinyl compounds, such as vinyl esters, especially vinyl acetate, vinyl alcohols and/or vinyl ethers.

The residual solvent content should be below 1% by weight.

By way of example, a description may be given of the following self-adhesive composition, for which the following monomer mixtures (amounts in % by weight) are copolymerized in solution. The polymerization batches are composed of from 60 to 80% by weight of the monomer mixtures and from 20 to 40% by weight of solvents such as petroleum spirit 60/95 and acetone.

The solutions are first freed from oxygen by flushing with nitrogen, in customary reaction vessels made of glass or steel (with reflux condenser, anchor stirrer, temperature measuring unit, and gas inlet pipe), and then heated to boiling.

By adding from 0.1 to 0.4% by weight of a peroxide initiator or azo initiator which is common for free-radical polymerization, such as dibenzoyl peroxide or azobisisobutyronitrile, for example, the polymerization is initiated. During the polymerization time of about 20 hours, dilution may be carried out a number of times with further solvent, depending on the increase in viscosity, so that the finished polymer solutions have a solids content of between 25 to 65% by weight.

Depending on requirement and suitability, the compositions prepared in this way are blended further and, following removal of the solvent, as described in EP 0 621 326 A1, are used for coating.

Depending on the formula and on the nature of the additives, blending is performed either before or after concentration in apparatus appropriately suitable for that purpose.

The monomer composition of the adhesive produced is as follows:

| | % by weight |
|---|---|
| 2-Ethylhexyl acrylate | 21 |
| n-Butyl acrylate | 21 |
| tert-Butyl acrylate | 50 |
| Acrylic acid | 8 |

It is also possible to use an adhesive from the group of the natural rubbers or the synthetic rubbers or any desired blend of natural and/or synthetic rubbers, the natural rubber or rubbers being selectable in principle from all available grades such as, for example, crepe, RSS, ADS, TSR or CV grades, depending on required purity and viscosity, and the synthetic rubber or rubbers being selectable from the group of randomly copolymerized styrene-butadiene rubbers (SBR), butadiene rubbers (BR), synthetic polyisoprenes (IR), butyl rubbers (IIR), halogenated butyl rubbers (XIIR), acrylic rubbers (ACM), ethylene-vinyl acetate (EVA) copolymers and polyurethanes and/or blends thereof.

Furthermore, and preferably, the processing properties of the rubbers may be improved by adding to them thermoplastic elastomers with a weight fraction of from 10 to 50% by weight, based on the total elastomer fraction.

As representatives, mention may be made at this point, in particular, of the particularly compatible styrene-isoprene-styrene (SIS) and styrene-butadiene-styrene (SBS) types.

As tackifying resins it is possible without exception to use all known tackifier resins which have been described in the literature. Representatives that may be mentioned include the rosins, their disproportionated, hydrogenated, polymerized, esterified derivatives and salts, the aliphatic and aromatic hydrocarbon resins, terpene resins, and terpene-phenolic resins. Any desired combinations of these and other resins may be used in order to adjust the properties of the resulting adhesive in accordance with what is desired. Explicit reference is made to the depiction of the state of the art in the “Handbook of Pressure Sensitive Adhesive Technology” by Donatas Satas (van Nostrand, 1989).

“Hydrocarbon resin” is a collective term for thermoplastic polymers which are colorless to intense brown in color and have a molar mass of generally <2000.

They may be divided into three main groups according to their provenance: petroleum resins, coal tar resins, and terpene resins. The most important coal tar resins are the coumarone-indene resins. The hydrocarbon resins are obtained by polymerizing the unsaturated compounds that can be isolated from the, raw materials.

Included among the hydrocarbon resins are also polymers obtainable by polymerizing monomers such as styrene and/or by means of polycondensation (certain formaldehyde resins), with a correspondingly low molar mass. Hydrocarbon resins are products with a softening range that varies within wide limits from <0° C. (hydrocarbon resins liquid at 20° C.) to >200° C. and with a density of from about 0.9 to 1.2 g/cm³.

They are soluble in organic solvents such as ethers, esters, ketones, and chlorinated hydrocarbons, and are insoluble in alcohols and water.

By rosin is meant a natural resin which is recovered from the crude resin from conifers. Three types of rosin are differentiated: balsam resin, as a distillation residue of turpentine oil; root resin, as the extract from conifer root stocks; and tall resin, the distillation residue of tall oil. The most significant in terms of quantity is balsam resin.

Rosin is a brittle, transparent product with a color ranging from red to brown. It is insoluble in water but soluble in many organic solvents such as (chlorinated) aliphatic and aromatic hydrocarbons, esters, ethers, and ketones, and also in plant oils and mineral oils. The softening point of rosin is situated within the range from approximately 70 to 80° C.

Rosin is a mixture of about 90% resin acids and 10% neutral substances (fatty acid esters, terpene alcohols, and hydrocarbons). The principal rosin acids are unsaturated carboxylic acids of empirical formula C₂₀H₃₀O₂, abietic, neoabietic, levopimaric, pimaric, isopimaric, and palustric acid, as well as hydrogenated and dehydrogenated abietic acid. The proportions of these acids vary depending on the provenance of the rosin.

Plasticizers which can be used are all plasticizing substances known from adhesive tape technology. They include, inter alia, the paraffinic and naphthenic oils, (functionalized) oligomers such as oligobutadienes and oligoisoprenes, liquid nitrile rubbers, liquid terpene resins, animal and vegetable oils and fats, phthalates, and functionalized acrylates.

For the purpose of heat-induced chemical crosslinking, it is possible to use all known heat-activatable chemical crosslinkers such as accelerated sulfur or sulfur donor systems, isocyanate systems, reactive melamine resins, formaldehyde resins, and (optionally halogenated) phenol-formaldehyde resins and/or reactive phenolic resin or diisocyanate crosslinking systems with the corresponding activators, epoxidized polyester resins and acrylic resins, and combinations thereof.

The crosslinkers are preferably activated at temperatures above 50° C., in particular at temperatures from 1 00° C. to 160° C., with very particular preference at temperatures from 110° C. to 140° C.

The thermal excitation of the crosslinkers may also be effected by means of IR rays or other high-energy electromagnetic alternating fields.

Further embraced by the concept of the invention is a polymer film such as may be obtained in one of the processes outlined in detail above.

Additionally, the polymer film of the invention may be used outstandingly as a carrier for a coating, especially a self-adhesive coating. This coating may be selected from the group disclosed earlier on above.

In the text below, the intention is to illustrate processes of the invention and polymer films produced by the process of the invention, with reference to a number of examples and figures, without wishing thereby to restrict the invention unnecessarily.

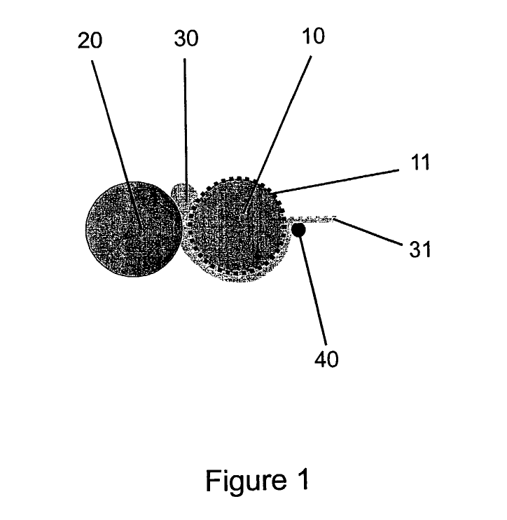

FIG. 1 shows the production of a nanostructured and microstructured polymer film by one particularly advantageous process,

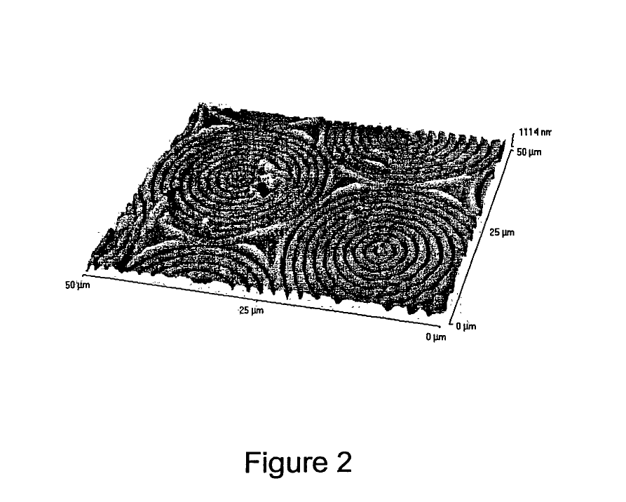

FIG. 2 shows the AFM (Atomic Force Microscopy) micrograph of the EVA replica of Example 1,

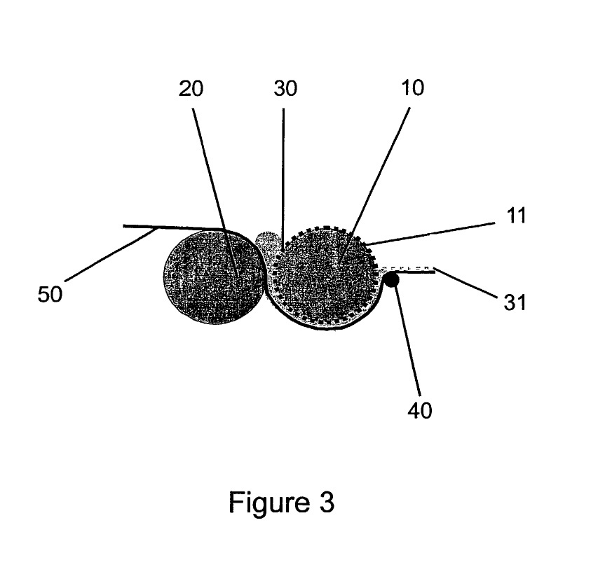

FIG. 3 shows the equipping of a carrier material with a polymer film in a further advantageous variant of the process,

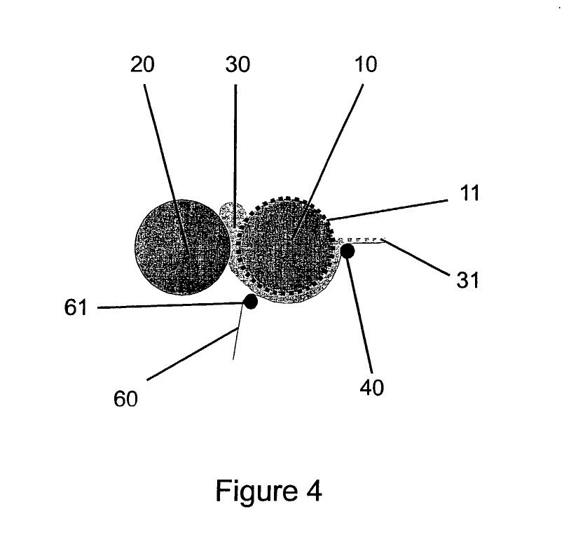

FIG. 4 shows the equipping of a mechanically or thermally sensitive carrier material with a polymer film, in a further advantageous variant of the process,

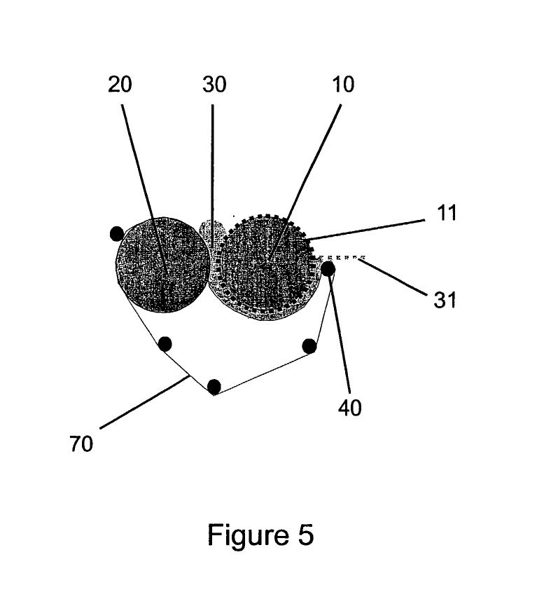

FIG. 5 shows the production of a nanostructured and microstructured polymer film by one particularly advantageous process, which uses a continuous process support,

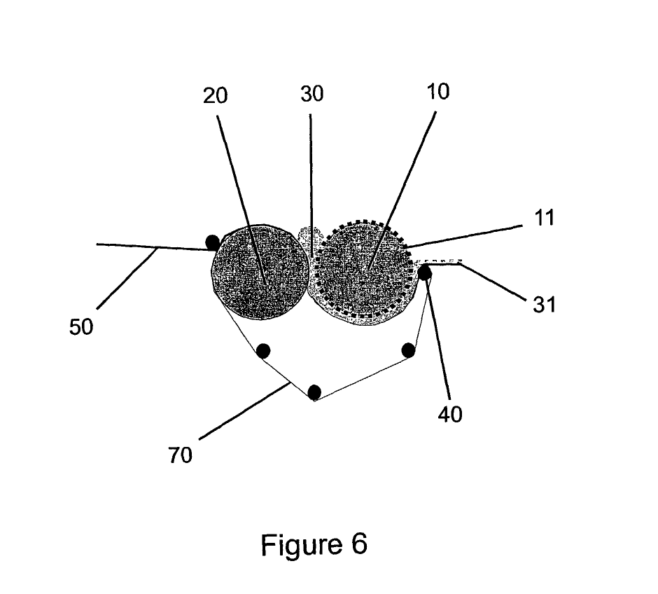

FIG. 6 shows the equipping of a carrier material with a polymer film in another advantageous variant of the process, which again uses a continuous process support.

### EXAMPLES

### Example 1

A form tool is produced by lithography with subsequent electroplating. The form tool carries, as structures, diffraction gratings having grid constants of from 1600 nm to 2100 nm at a depth of approximately 1000 nm. The diffraction gratings are arranged so that when irradiated with white light they produce an indicium featuring different colors.

The tool is placed around a magnetic cylinder of a two-roll unit. The magnetic cylinder is cooled to 23° C., driven at a speed of 1 m/min, and wetted with a very thin film of water by means of a cotton fabric.

The second roll is not driven and is heated at 140° C. The rolls are pressed against one another with a linear pressure of 30 N/mm, with a gap (nip) of 50 μm. Using an extruder, a polyethylene (PE) melt is delivered, initially in excess, into the nip until a polymer melt bead with a diameter of about 2 cm is formed. Thereafter, the delivery of the extruder is reduced so that the bead remains constant.

The polymer is drawn by the structured roll through the nip and, after the nip, is cooled thereon, so that it can be taken from the roll in the form of a structured film by means of a deflecting roll.

The polymer impression in web form that is produced in this way is notable for a very high quality of reproduction. The structure depth of the master, of about 1.0 μm, can be transferred approximately to the copy (see FIG. 2, AFM micrograph of the EVA replica).

With rotary embossing and an identical master, on the other hand, depths of only 100 to 300 nm can be achieved.

The process is shown in FIG. 1. The equipment which is preferably used here is composed of the roll 10, which is provided with the negative relief 11. The polymer bead 30 is drawn into the nip between backing roll 20 and roll 10 and is pressed into the relief 11.

Finally, the nanostructured and microstructured polymer film 31 is taken off via the take-off roll 40.

### Example 2

A 25 μm, biaxially oriented polyester film is provided by a laser with a holographic topography which is continually repeated on the film, so resulting in a “scatterprint”. The film is fastened to the cooled roll by means of a double-sided adhesive tape, tesaprint ® 52916 [polyester-based backing (25 μm), adhesive based on resin-modified acrylate].

The second roll is heated to 140° C. A 25 μm PET film is supplied upstream of the nip by the backing roll. The two rolls form a nip of 10 μm.

As in Example 1, an extruder generates a PE polymer bead in the nip between the two rolls, which run synchronously at 1 m/min.

The prevailing nip pressure of˜40 N/mm, and the high temeprature, provide for good anchoring of the structured PE film and the PET carrier film. The low thickness of the polymer melt layer ensures rapid cooling and allows high web speeds. These speeds can be increased still further by using a nitrogen cooling lance upstream of the take-off roll.

The process is shown in FIG. 3. The equipment which is preferably used here is composed of the roll 10, which is provided with the negative relief 11. The polymer bead 30 is drawn into the nip between backing roll 20 and roll 10 and is pressed into the relief 11.

At the same time, the carrier material 50, in this case a PET film, runs in via the backing roll 20, and does so upstream of the nip.

Finally, the carrier material 50 together with the nanostructured and microstructured polymer film 31 which is present on it is taken off via the take-off roll 40.

### Example 3

Grayscale lithography was used to produce prisms having an edge length of 10 μm and a height of 7.5 μm on Si wafers. The wafers were sawn into squares with an edge length of 8 cm. A UV-crosslinking silicone release varnish (UV 9400 99% (an epoxide-functionalized silicone), initiator UV 9380 C 1% (UV initiator which initiates acid-catalyzed crosslinking), both from the company GE Silicones) is applied using a coating bar to a physically pretreated 20 μm BOPP film. The sawn wafers are placed in the coating film in such a way that they produce a virtually seamless structuring of the varnish. Finally, the varnish is cured in 5 minutes using a UV lamp (wavelength 253 μm).

The structured film thus produced is fastened to the roll as disclosed in Example 2.

The roll is cooled down until a layer of condensation is formed on it (about 8° C.). The structured roll is driven at a speed of 1 m/min.

The second roll is not driven and is heated to 140° C. The rolls are pressed against one another with a linear pressure of 30 N/mm, with a nip of 20 μm.

Comparably with Example 1, an extruder generates a PE polymer bead in the nip between the two rolls. Directly after leaving the nip, a transparent PE film 50 μm thick is supplied to the cooling melt via a contact roll.

As a result of the residual heat of the structured polymer film, the two films are welded together. The assembly is removed from the shaping roll by a take-off roll.

The process is shown in FIG. 4. The equipment which is preferably used here is composed of the roll 10, which is provided with the negative relief 11. The polymer bead 30 is drawn into the nip between backing roll 20 and roll 10 and is pressed into the relief 11.

At the same time, the carrier material 50, in this case a PE film, runs in via a contact roll 61, and does so downstream of the nip.

Finally, the carrier material 50 together with the nanostructured and microstructured polymer film 31 which is present on it is taken off via the take-off roll 40.

FIGS. 5 and 6 show the production of a nanostructured and microstructured polymer film by a particularly advantageous process embodiment, which uses a continuous process support, and the equipping of a carrier material with a polymer film in a further advantageous variant of the process, likewise using a continuous process support.

In the process according to FIG. 5, the equipment which is preferably used here is composed of the roll 10, which is provided with the negative relief 11. The polymer bead 30 is drawn into the nip between backing roll 20 and roll 10 and is pressed into the relief 11.

Finally, the nanostructured and microstructured polymer film 31 is taken off via the take-off roll 40.

In order to ensure that the polymer film 31 is not damaged after passing through the nip, it is supported by a self-contained process support 70.

The process support, 70, runs over the backing roll 20 and partly along the roll 10. The process support 70 is separated by the take-off roll 40 from the roll 10 and from the polymer film 31 and is passed back again via guide rolls to the backing roll 20.

FIG. 6 shows the process according to FIG. 5, in which at the same time, upstream of the nip, the carrier material 50 runs in via the backing roll 20.

What is claimed is:

1. A process for producing nanostructured and microstructured polymer films comprising a) guiding a polymer into a gap formed by a roll and a means which develops an opposing pressure and b) pressing the polymer through the gap so that, after the gap, the polymer lies in the form of a polymer film on the roll, wherein wrapped around the roll is a form tool which is provided with a relief which represents a negative of a surface structure to be produced on the polymer film, so that a near-roll surface of the polymer film is shaped in accordance with the relief.

2. The process as claimed in claim 1, wherein said means is a doctor blade or a backing roll.

3. The process as claimed in claim 1, wherein the roll is heated or cooled and/or the means, is heated at above the melting point of the polymer used.

4. The process as claimed in claim 1, wherein the form tool is provided with the relief by sandblasting, etching, laser ablation, lithographic techniques, offset printing, electroplating techniques, LIGA, cutting, milling and/or erosion.

5. The process as claimed in claim 1, wherein the form tool is composed of a polymer.

6. The process as claimed in claim 5, wherein the form tool is composed of crosslinked silicone or PET.

7. Process as claimed in claim 1, wherein the form tool is composed of a metal.

8. The process as claimed in claim 1, wherein the form tool is produced from a roll or a sleeve.

9. The process as claimed in claim 1, wherein the form tool is fastened detachably on the roll by means of a double-sided adhesive tape.

10. The process as claimed in claim 1, wherein the structure depth of the surface of the form tool is between 10 nm and 1000 μm.

11. The process as claimed in claim 1, wherein the polymer film is produced on a carrier material which on the roll-remote side of the elastomeric polymer is guided into the gap formed by roll and means and is guided along the roll surfaces.

12. The process as claimed in claim 1, wherein the polymer film is produced on a support material which is guided on the roll-remote side of the elastomeric polymer, after the gap formed by roll and means, onto the roll.

13. The process as claimed in claim 1, wherein the polymer forms a rotating bead between carrier and form tool.

14. The process as claimed in claim 1, wherein, in order to support the polymer film, a self-contained process support is present which is guided via the means and the roll in such a way that the polymer or polymer film is continually situated between process support and roll.

15. The process as claimed in claim 1, wherein the polymer is thermoplastic, is in softened or melted form, is a polymer blend and/or a polymer-bound release.

16. The process as claimed in claim 15, wherein the polymer comprises N,N′-ethylenebisstearamide.

17. The process as claimed in claim 1, wherein the polymer is blended with colorants .

18. The process as claimed in claim 17, wherein the polymer is blended with TiO₂ carbon black and/or with fillers such as chalk.

19. The process as claimed in claim 18, wherein, after structuring, the polymer is subjected to crosslinking.

20. The process as claimed in claim 19, wherein the polymer is subject to crosslinking by means of ionizing radiation.

21. A polymer film obtained in a process as claimed in claim 1.

22. A coating comprising as a carrier a polymer film according to claim 21.

23. The coating according to claim 23, which is self-adhesive.
